(19) United States
(12) Patent Application Publication
(10) Pub. No.: US 2026/0058731 A1
(43) Pub. Date: Feb. 26, 2026

(54) DATA TRANSMISSION SYSTEM AND METHOD

(71) Applicant: John K. Piraino, Woodland Hills, CA (US)

(72) Inventor: John K. Piraino, Woodland Hills, CA (US)

(21) Appl. No.: 18/781,002

(22) Filed: Jul. 23, 2024

Related U.S. Application Data
(60) Provisional application No. 63/529,030, filed on Jul. 26, 2023.
(60) Provisional application No. 63/623,070, filed on Jan. 19, 2024.
(60) Provisional application No. 63/634,172, filed on Apr. 15, 2024.

(51) Int. Cl. H04B 10/70; H04B 10/112

(52) U.S. Cl. CPC H04B 10/70; H04B 10/1129

(57) ABSTRACT

A data transmission system and methodology include providing at least a pair of arrays, each including a matrix containing entangled qubits, such as at a broadcaster or sender site. When qubits of the broadcaster site are acted upon or otherwise activated, the qubits at the end user site are instantly affected in exactly the same manner such that the signal or information is instantly transferred to the end user.

### RELATED APPLICATIONS

1This application claims the benefit of U.S. Provisional Application No. 63/634,172 filed on Apr. 15, 2024, and also claims the benefit of U.S. Provisional Application No. 63/623,070 filed on Jan. 19, 2024, and also claims the benefit of U.S. Provisional Application No. 63/529,030 filed on Jul. 26, 2023.

### FIELD OF THE INVENTION

The present invention generally relates to data transmission systems and methods. More particularly, the present invention relates to a data transmission system and method utilizing quantum particle entanglement technology to create stable and efficient interconnections for audio and/or video data transmission.

### BACKGROUND OF THE INVENTION

Data has been sent via non-electronic means (e.g., optical, acoustic, mechanical) since the advent of communication. Analog signal data has been sent electronically since the advent of the telephone. Data has also been transmitted via electromagnetic signals, via wires or wireless, using radio frequencies, television signals, etc.

More recently, data streaming over the internet and other networks has become a common occurrence. The technologies used to manage these huge amounts of streaming data belong to a group of strategies called “internet protocols”. Internet protocols (IP) began when the trans-Atlantic cable from London to New York was created in the nineteenth century. A problem to overcome when implementing this was how to manage hundreds or even thousands of simultaneous voice streams over a single cable. The solution was accomplished through a process called “multiplexing”, a technique designed to send hundreds of simultaneous audio conversations at the same time.

Multiplexing “slices” each audio or other data signal into tiny parts called “data packets”. Data packets are so small that each packet from one hundred audio conversations, as an example, can be transmitted in less than a second. Once the data packets reach their intended destination, they are reintegrated into their original data streams based on code keys attached to each data packet. In the example of the trans-Atlantic cable, when data packets reached New York from London, they were reintegrated into a single data stream according to the code key attached to that packet and would appear to a listener as one continuous stream of spoken data.

Current internet technologies for data transmissions include simple text messages, audio signals, video signals and many other types of data. Managing these many thousands of different, simultaneous data streams over the internet is a daunting task.

Signals sent over the internet still use multiplexing technology of parsing, transmitting and reintegrating various audio, video and other signals. In traditional multiplexing systems and methods, broadcast servers send pre-parsed and non-parsed streaming data to a local web transmission server where the streaming data is parsed into data packets or frames along with other inbound streams. After parsing, the data packets are sent to the web server's multiplexing processor, where packets are placed in the transmission que and then transmitted to the web. The “web” is a large number of internet servers, which may be viewed as a “cloud” of web servers.

Other inbound data streams entering the local web transmission server create huge processing loads to these servers because most of the inbound data is not pre-parsed, and even if the data is pre-parsed at a broadcast site, the pre-parsed data packets may still need to be parsed again which defeats the gains of any pre-parsing process performed at the broadcast server. Data packets that are too big will be re-parsed by the transmission server. If the packet size is too small, then too many packets were unnecessarily created for the transmission. The unnecessarily created packets will add to the processing burden, and also slow down the de-multiplexing process or reintegration of the data stream near the end user site since those additional packets will have to be reintegrated into the final data stream for a cohesive and complete view of the end user, thus reducing transmission speed as well.

Servers in a typical IP network support processing burdens associated with up to hundreds of servers. Traditional multiplexing still requires the use of hundreds of intervening web servers, with the heaviest loads on local web servers that reintegrate transmission signals near end users.

At the web server near the end user site, often referred to as a local web server, data packets have header information that relates to each packet and to other packets. When the data packets arrive at the local web server, they are put in order by software on the local web server, adding more overhead and burden to the system. This is currently required, however, to reintegrate the various data packets into a smoothly streaming signal for use by the end user.

Currently, all data transmission systems and methodologies have drawbacks. In the case of wireless data transmission, large objects, such as buildings, mountains, etc. can create dead zones where the data signal is not obtainable. Even when wired transmission is utilized, data transmission can be complicated and require cables. Both methods require an amount of time in order for the data to be transmitted, particularly over long distances.

Accordingly, there is a continuing need for a eliminating the processing burdens currently used IP network systems and processes. There is also a continuing need for transmitting data, such as audio and/or video data in real time, even over vast distances. 1 The present invention fulfills these needs, and provides other related advantages.

### SUMMARY OF THE INVENTION

The present invention relates to a data transmission system and related method which is able to transmit or transfer or otherwise relay data, such as audio and/or video data, in real time, even over vast distances.

The data transmission of the present invention generally comprises a first array comprising a matrix having a plurality of quantum particles associated therewith. A second array is disposed a distance from the first array. The second array comprises a matrix having a plurality of quantum particles associated therewith. The quantum particles of the first and second arrays are entangled so as to enable data to be transmitted therebetween.

The matrix of the first and second arrays may comprise graphene. The graphene matrix may comprise a single graphene layer in thickness. The quantum particles may be disposed within the hexagonal spaces of the graphene.

The first and second arrays each include a first layer of material over a first surface of the matrix and a second layer of material over a second surface of the matrix that retains the quantum particles in association with the matrix and enable data to be applied to the quantum particles. The quantum particles may comprise qubits. Preferably, at least one of the first and second layers of each of the first and second arrays is translucent or transparent. At least one of the first and second layers may be comprised of a crystalline material. At least one of the first and second layers may comprise condensed carbon, such as diamond.

A method for transmitting data in accordance with the present invention generally comprises the steps of providing a first array comprising a matrix having a plurality of quantum particles associated therewith. A second array comprising a matrix having a plurality of quantum particles associated therewith is also provided.

A first layer of material is placed on a first side of the matrix and a second layer of material is placed on the second side of the matrix of each of the first and second arrays to hold the quantum particles in association with the matrix and enable data to be applied to the quantum particles. Preferably, the first and second layers of material are transparent or translucent. The first and second layers of material may comprise condensed carbon, such as diamond. Typically, the quantum particles comprise qubits.

The quantum particles of the first and second matrices are entangled. The first and second arrays are positioned a distance from one another. The quantum particles of the first array is exposed to data, whereby the data is transmitted, or otherwise relayed, to the quantum particles of the second array.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a top perspective view of an array embodying the present invention;

FIG. 2 is an exploded perspective view of the array of FIG. 1, illustrating the component parts thereof;

FIG. 3 is an enlarged diagrammatic view of quantum particles disposed within hexagonal spaces of a graphene matrix, in accordance with the present invention;

FIG. 4 is a diagrammatic view of two arrays disposed a distance from one another, in accordance with the present invention;

FIG. 5 is a diagrammatic view of data, in the form of an image, projected onto a first array, and transmitted, or otherwise transferred, to a second array which is entangled therewith;

FIG. 6 is a bottom perspective view of a drone having an array embodying the present invention associated therewith; and

FIG. 7 is a diagrammatic view of a battlefield incorporating the present invention.

### DETAILED DESCRIPTION OF THE PREFERRED EMBODIMENTS

As shown in the accompanying drawings, for purposes of illustration, the present invention resides in a data transmission system and related method. The system of the present invention overcomes the drawbacks and shortcomings of currently used data transmission systems, including IP network and multiplexing methodologies. In particular, the present invention overcomes the need for local web transmission servers, myriad of local web servers and the many interconnecting web servers in between, and transmitting or otherwise relaying data through large objects or over long distances.

Optimal network communications should include methodologies to connect broadcasters directly to end users without multiplexing, multiple web servers or other intervening technologies. Such optimal communications should also allow for direct user to user connectivity, such as for applications like cell phone communication. Until the present invention, no single technology existed that would provide unlimited interconnections between these parties using the same general schema.

The present invention utilizes quantum particle (typically qubit) entanglement technology to create stable and efficient interconnections for broadcasters, end users and others. A qubit is a quantum bit, the counterpart in quantum computing to the binary digit or bit of classical computing. Just as a bit is the basic unit of information in a classical computer, a qubit is the basic unit of information in a quantum computer. Due to entanglement, qubits can take the value of two bits of data. Two qubits can take the values of four bits, etc. This is due to the qubit being able to be in a 1, a 0 or a super position of both, called a quantum state. This ability enables qubits to complete equations much quicker than bits.

Objects that share a quantum entanglement have linked properties. It is theoretically possible to build a network of connected qubits that are entangled with qubits elsewhere in the network, rather than with their direct neighboring nodes or servers within the network. The physics of entangled quantum particles or qubits means that a “cause” at one end of an entangled qubit is already connected to the other entangled qubit so that the net entangled particles act as a single fixed system. This is why the information appears to travel faster than the speed of light and intervening physical objects, such as mountains or even the planet earth, pose no problem for communication between entangled qubits.

Entangling quantum particles creates a new level of communication far beyond multiplexing. In accordance with the system and methodology of the present invention, no web servers and no physical instrumentality between broadcasters and end users is needed. The only instrumentality required is at the broadcast site and the end user site. Quantum entanglement can occur at any distance wherever the end users may be located, such as being thousands or more miles apart or even opposite sides of the earth.

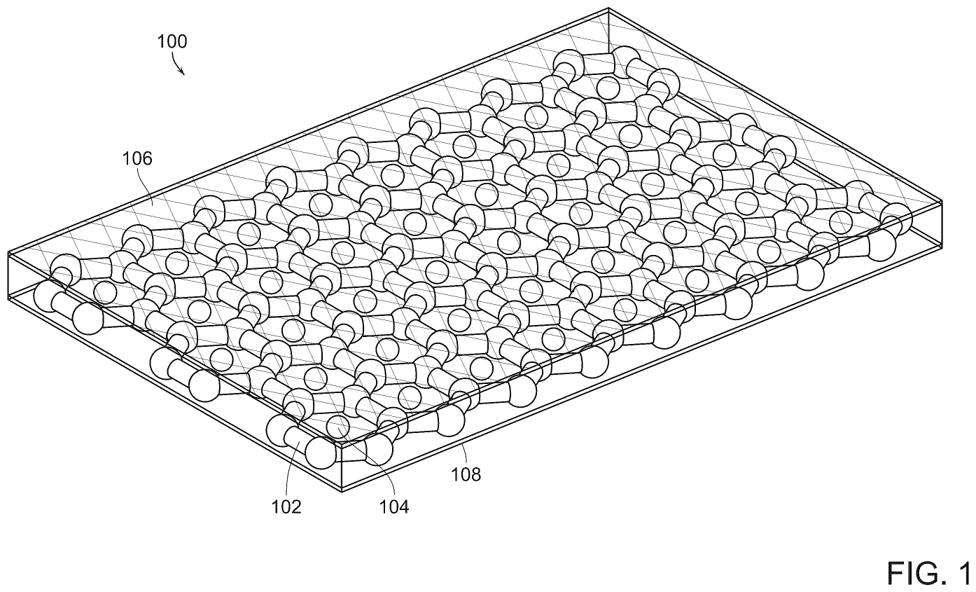

It is desirable, and perhaps necessary, to confine the qubits in a specific location, both on the transmission and receiving side to obtain a stable length for the data to be transmitted, including audio and/or visual data. In accordance with the invention, arrays are created to hold the quantum particles and use them in accordance with the present invention, such as the array 100 illustrated in FIG. 1. A typical array 100 embodying the present invention comprises a matrix 102 having a plurality of quantum particles 104, such as qubits. Typically, a first layer of material 106 is placed over a first surface of the matrix 102 and a second layer of material 108 is placed over a second surface of the matrix 102, so as to retain the quantum particles 104 in association with the matrix and enable data to be controllably applied to the quantum particles. Preferably, at least one of the first and/or second layers 106 and 108 may be translucent or transparent. At least one of the first and second layers 106 and 108, or both layers 106 and 108, may be comprised of a crystalline material. In this manner, visual data may be projected onto the array 100, such that it passes through the top layer 106 and acts upon the quantum particles 104.

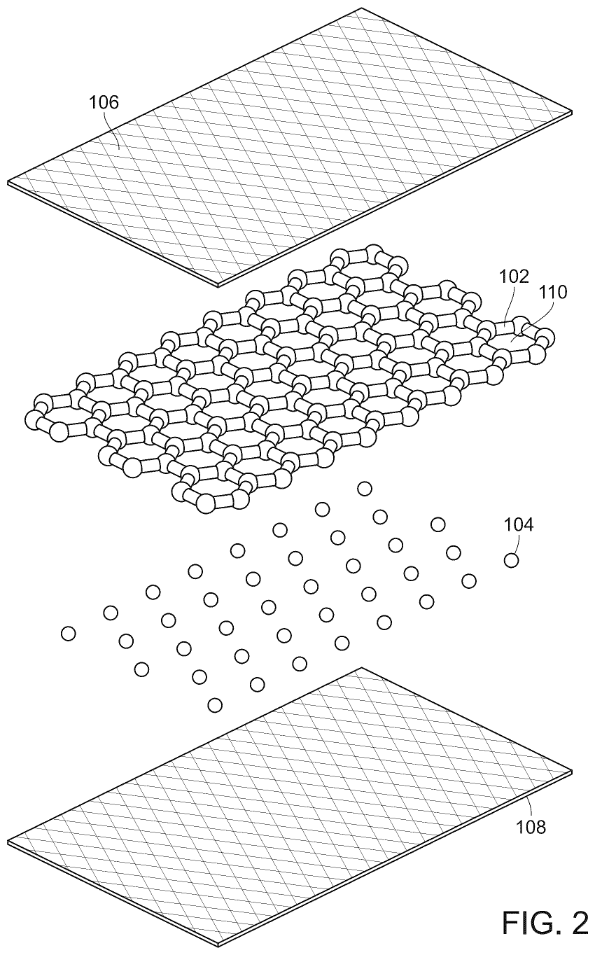

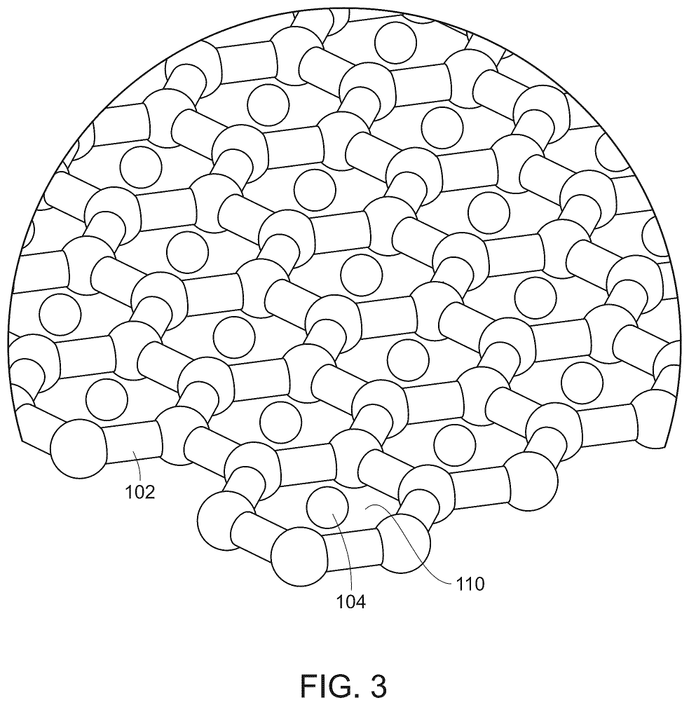

With reference now to FIGS. 2 and 3, in a particularly preferred embodiment, in order to hold the qubits 104 in place to enable entangling the qubits 104, the present invention may implement the use of a graphene matrix 102 at both the broadcaster site and the receiving end user site. The qubits 104 are trapped inside the six-sided pockets 110 of the graphene molecules of the matrix 102.

Graphene is created using carbon atoms which strongly interlink to create a hexagonal structure. As graphene creates a six-sided structure, it provides an area or pocket 110 therein bounded by six sides. Such a graphene matrix 102 is used at both the sender or broadcaster site and the end user receiving site. The graphene matrix 102 may be very thin, such as one atom in thickness of graphene.

While the graphene can hold a qubit 104 in place in a six-sided molecular structure of the graphene matrix, the six-sided graphene matrix cannot close off the top and bottom “openings”. So, to fully stabilize the qubits 104, and keep them in place inside its assigned six-sided pocket 110, a material layer is applied to the top and bottom of the six-sided graphene matrix 102 so that the qubits 104 cannot escape out of the six-sided cells 110. This in essence creates a sandwich of the upper and lower layers of material 106 and 108, with the graphene matrix 102 and qubits 104 therebetween. The upper and lower layers 106 and 108 should be comprised of a material which enables the qubits 104 to be formed, activated, and/or entangled.

In a particularly preferred embodiment, the upper and lower layers 106 and 108 are comprised of a material made of condensed carbon atoms. These condensed carbon atoms create essentially a diamond sheet which is very thin, such as being only one atom in thickness. These one-atom-thick diamond layers 106 and 108 confine the qubits 104 inside each six-sided graphene matrix pocket 110. The very thin diamond or carbon layers 106 and 108, however, still allow light to travel through to the enclosed qubits 104 inside of this sandwich array 100. This transparency enables the qubits to be formed, activated, entangled, etc. as necessary in accordance with the present invention.

An advantage of using a carbon-based, or even a single atom thick condensed carbon layer, such as a diamond layer, is that these layers 106 and 108 are comprised of carbon atoms, just like the carbon matrix 106. Thus, the outer surface layers 112 and 114 should readily attach to the graphene matrix 102, with some application of pressure, heat or other energy. With the application of the upper and lower layers 106 and 108, the qubits 104 are trapped within the pockets 110 of the graphene matrix 102 and thus stabilized and held in place.

The qubits 104 within the graphene matrix 102 can be created in various methods, including those that are currently known. One way to create the qubits may be to shine a strong enough light onto the graphene matrix 102 which will leave qubits or photons 104 trapped therein. To create a qubit, an area of material which can be accessed and controlled with the quantum properties is accessed, and then light or magnetic fields may be used to create superposition, entanglement, and other properties.

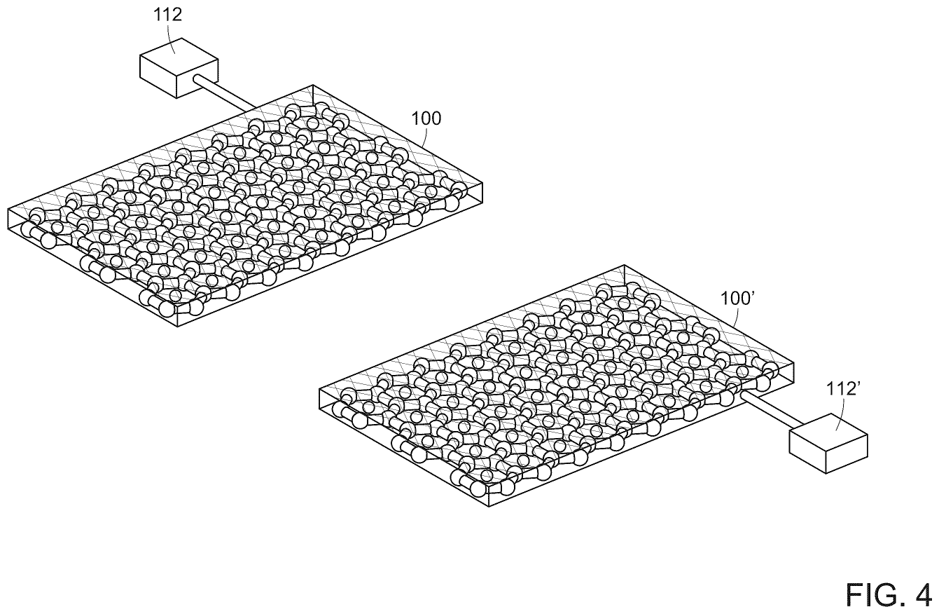

Multiple arrays or screens, as illustrated in FIG. 4, are created, such that there is at least one array 100 at a broadcast site and at least one array 100′ at an end user site. For example, a pair of arrays or screens may be made. Such a screen or array 100 may be of various sizes and may include a large number of qubits, such as thousands, millions, or even trillions of qubits 104. Preferably, the arrays or screens 100 and 100′ are substantially identical or mirror images of one another. There may be as few as a single array 100 at a broadcaster site and a corresponding single array 100′ at the end user site, although it will be appreciated that there can be multiple arrays 100 at the broadcast site and/or multiple arrays 100′ at the end user site. There could be a corresponding number of arrays at the broadcaster site and end user site, or an array 100 at a broadcasting site may be entangled with multiple receiving arrays 100′ at the end user site.

At least two of the arrays, however, such as one array 100 at the broadcast site and another array 100′ at the end user site, are entangled with one another so as to enable the transmission of data therebetween. The term “transmission” as used herein may not be in the traditional sense or definition, but rather refers to the relaying, sharing, conveying or other transfer of data between the quantum particles, such as qubits 104, of the entangled arrays. In accordance with quantum theory, entangled quantum particles, such as entangled qubits 104, respond immediately and in real time when the quantum particles, such as qubits 104, of an entangled array is acted upon. Thus, data, such as a video or audio source or the like, which is projected into, captured, or otherwise conveyed to the qubits or other quantum particles of a first array will immediately cause the qubits or other quantum particles of the entangled array to have those qubits or quantum particles react in the same manner, such as if the data was imparted directly onto the receiving end user array's quantum particles or qubits.

An entangled state of two qubits can be made via a gate on the control qubit, followed by the controlled-NOT (CNOT) gate. This generates a particularly maximally entangled two-qubit state known as a Bell state. This can be done with all of the qubits of the array. Entanglement is when qubits 108 have a relationship to each other that prevents them from acting independently. It happens when a quantum particle has a state, such as spin or electric charge, thus linked to another quantum particle state. This relationship persists even when the particles are physically far apart, even far beyond atomic distances. It is believed that such distances could in fact be vast differences of not only many miles, but distances between continents or even greater.

Once entangled, the qubits 104 of the respective arrays 100, 100′ are able to “communicate” with one another by “sending” data. However, in accordance with the quantum physics of qubits and the present invention, such signal is not sent or communicated in the traditional sense, but rather when one qubit is acted thereupon, the other qubit is instantly and similarly acted thereupon. For example, a light shining on one entangled qubit will instantly appear as a light in the entangled qubit partner instantly, no matter how far away the entangled qubit partner actually is. Thus, if a red light were to be shined upon the array 100, which may be placed at the Los Angeles airport, at the same instant, a red light will appear in the array 100′, whose qubits are entangled with array 100, which may be placed many miles away from the Los Angeles airport, such as at an airport in New York, Paris, or even the moon.

With continuing reference to FIG. 4, electronic circuits, such as electronic devices 112 may be associated with each array 100 for capturing, analyzing, comparing, etc. the data received or “transmitted” either directly onto the quantum particles or qubits 104 of the array 100 or received from another corresponding, entangled array. Such electronics 112 may include microcontrollers, computers, sensors, microcircuitry or the like.

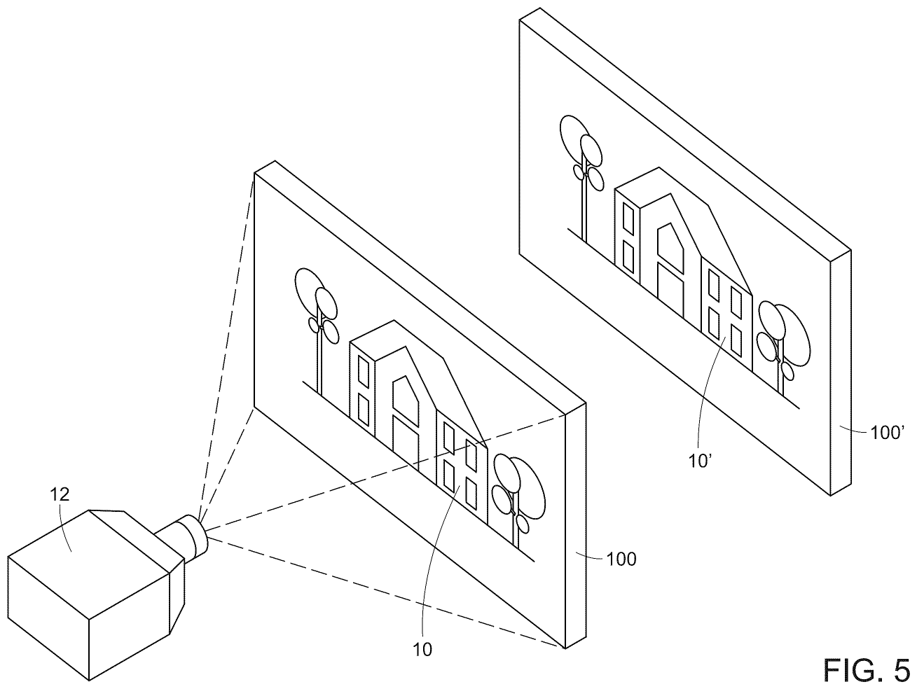

Once the qubits of the arrays are entangled, virtually any effect on qubits in the first array will appear instantly in the qubits of the other array. Thus, as illustrated in FIG. 5, the first array is used like a blank screen onto which an image or movie 10 may be projected by an ordinary projector or motion picture projector 12. The broadcaster's or sender's graphene scaffolding of its array 100 holds qubits 104 in fixed locations, waiting for “data”, such as from the illustrated exemplary “movie projector” 12. All information, including moving images and sound that are projected against the surfaces of array 100 will instantly appear in array 100′ and the movie so projected will proceed with the same normality as in a movie theater.

Of course, the “movie projector” 12 could represent any source of data to be transferred. Microcircuits 112 associated with the graphene 102 can activate the entangled qubits 104 as a signal or information is obtained and relayed to the qubits. The projector 12 at the broadcast site 100 instantly affects the qubits at the end user site in exactly the same way that the broadcast qubits are affected. Thus, the signal is instantly sent to the end user, which could be a television, cell phone, or any other electronic device capable of receiving the signal. This is done without any intermediary devices, such as servers, and without the need for multiplexing as is conventionally done. This could also be done across vast distances between the sender and receiver. Thus, the amount and/or speed at which the data is transmitted is significantly increased. The time and power or energy required to transmit the data is significantly decreased.

For TV, a moment of reflection will reveal that the need for costly transmission, telephone poles, electronic circuits, microwave towers and the like will no longer be required. The degree of motion picture and sound resolution would be based only on the number of qubits within the arrays. The transmitted data could be provided by any means, including an ordinary movie projector. The data transmitted will not be degraded from the original quality and clarity in sound or appearance. This will be regardless of the position or distance from each other of the arrays.

Thus, data and information can be transmitted or transferred between the entangled arrays in real time. This enables communication between the arrays, such as audio and/or visual information being conveyed between the arrays. Such information could be conveyed by applying sound waves, such as in the form of audio, and/or video, and upon such sound waves or audio or visual signals being applied to the qubits of the first array, the entangled qubits of the second array will instantly convey and communicate the sound waves, audio and/or visual information. This could enable instantaneous broadcasting of video and/or audio and provide instantaneous communication, notwithstanding vast distances between the entangled arrays. Thus, communication in every form including telephone, walkie-talkie, movies, radio, television, cell phone communication or the like could occur between the arrays having entangled qubits. This could enable, for example, the “transmission” of such data in an instantaneous manner from the earth to the moon or other planets or spaceships or the like, which would otherwise take the time that would be required for the speed of light to travel such great distances. Once the qubits inside of the two graphene sandwich arrays are entangled with one another, they will remain entangled and can be moved to almost anywhere, whether it be the next room, the other side of the country or even the other side of the earth, the moon, or beyond and the entangled qubits will remain entangled and be able to convey data and information therebetween in an instantaneous manner.

The implementation of the present invention can have large implications. It will be understood by those skilled in the art that wide implementation of the present invention could eliminate the need for all other current communication methodologies and strategies. There would no longer be need for telephone poles, underground or under water communication cables, cell towers, orbiting satellites, walkie-talkies, radio or even television signal transmission strategies and repeaters, related gear, etc. Instead, these could be replaced by the broadcasting array 100, as described above, and the corresponding end user or receiving arrays 100′. There will be no “no service” or dead zones as the “transmitted” information will be “received” instantaneously by the entangled qubits of the end user receiving array 100′ as the qubits at the broadcasting array 100 are altered or otherwise acted upon or activated at the broadcasting array. As the qubits are entangled between the arrays 100 and 100′, it is conceivable within the present invention that there is not just a one-way communication, but also a two-way communication between the entangled arrays. This is anticipated to be the case regardless of whether buildings, mountains, large distances between the arrays, etc. are present.

The system and methodology of the present invention has many applications and can be used in a wide variety of circumstances. For example, instead of being stationary, the broadcasting array 100 could be mobile and receive information relating to objects, information, areas, etc. that the broadcasting array 100 comes into visual or audible contact with. Similarly, the receiving arrays 100′ of the present invention could be either stationary or mobile. This would enable those with the receiving array tied to a broadcasting array to receive information from the broadcasting array at any time and at any location.

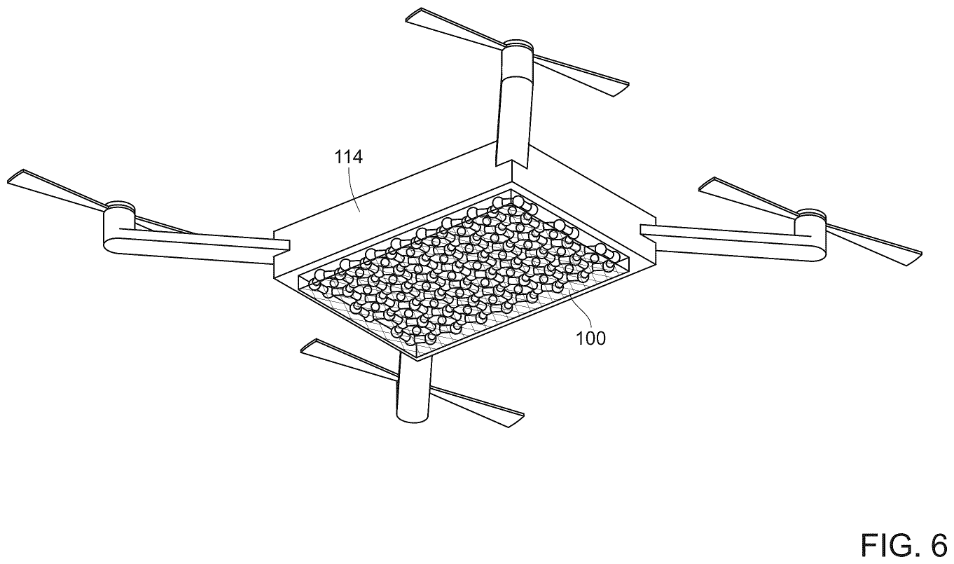

With reference to FIG. 6, one example of this would be the association of a broadcasting array 100 to a flying object, such as a drone 114. Such a flying object could alternatively be a helicopter, airplane, etc. It is also contemplated that the moving object could comprise other vehicles, such as motorcycles, cars, tanks, etc. The vehicle 114 could be moved into a location of interest such that the broadcasting array 100 would pick up visual and/or audible information for immediate transmission or transfer to a corresponding one or more receiving arrays, as described above.

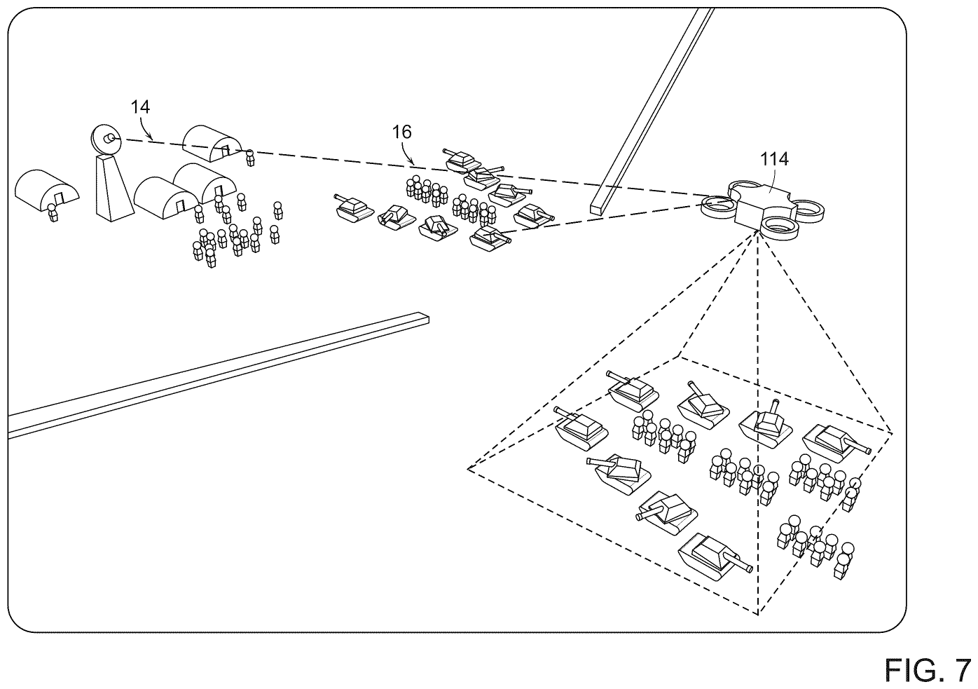

This could be helpful, for example, in military applications. One or more drones 114 could be used in a battlefield application, wherein overhead drones'data acquired by the broadcasting array 100 could be broadcast from the broadcasting array 116, which is attached or otherwise associated with the drone 114 to one or more receiving arrays. Such an array could be at the military headquarters 14, or even receiving arrays associated with groups of soldiers 16 or even individual soldiers, as illustrated in FIG. 7. For example, troops could wear earpieces or eyewear with the receiving array or be otherwise linked to a receiving array. In this manner, the soldiers could be informed of various aspects of the battlefield, such as informing the soldier or group of soldiers that, for example, a sniper is one hundred feet ahead of their position at a particular location, such as in a rose garden, behind a wall, etc. Such information could additionally, or alternatively, be relayed to tank commanders, artillery gunners, military aircraft, such as helicopters or fighter jets or the like. As the transmitted information could be instantaneous and without regard to distance or objects therebetween, such information could be conveyed much more quickly and efficiently than current audio and/or visual systems and methods. The broadcasting and receiving arrays could be incorporated into conventional audio/visual systems as well, as needed or deemed necessary.

The system of the present invention could also be used in other settings to gather information. Such information gathering could be for military purposes, security purposes, surveillance purposes, government intelligence purposes, etc. Small vehicles, such as a small drone, could have a broadcast array 100 associated therewith so as to gather information which the drone or vehicle comes into contact with, passes over, etc.

For example, every building has doors and windows, which are temporarily opened, or that have gaps so as to permit air to flow therethrough. Buildings also have ventilation that may be connected or may be associated with HVAC units and the like. Very small drones or robots for example, having a broadcasting array 100 associated therewith could be passed through such open doors, windows, or the openings of such doors or windows or even ventilation piping, etc. Such a drone, or other robotic vehicle, could be very small, such as the size of an insect, such as a fly, or even smaller. Such a device could be so small that it could navigate through the air with no noise factor at all since air displacement would be so miniscule that sound waves would be lost against the background ambient sounds. For example, a drone could be a fraction of an inch in size, or even the size of a small insect, and have a broadcasting array 100 associated therewith. Such micro dimensions could escape detection as the drone flies through the air.

While the broadcasting array 100 would be small, the micro-carbon lattice or other structure could contain many thousands of qubits in each of the six-sided pockets. As mentioned above, the qubits 104 are held in place with very small thickness diamond sheets or the like, such as a one-atom-thick sheet. There would be enough pockets, such as in the thousands, in the lattice structure of the array 100 to provide a detailed view so that sufficiently detailed images could be of great value.

For example, a lattice matrix could have enough qubits or “pixels” 104, that, at a sufficient distance, such as several feet or more, to provide a clear and detailed image of an ordinary printed document in enough resolution so as to be easily readable with normal type fonts of a smaller size. Images of other objects or individuals could also be obtained. The broadcasting array 100 would not necessarily be limited to visual objects, but also could eavesdrop on verbal discussions, or other audio sources.

The drone or other vehicle could potentially be inserted and then extracted from the desired location without detection. Given the technology of the present invention, images and/or sounds would be immediately conveyed to a receiving array. Thus, even if the array carrying vehicle were captured, the information will have already been relayed or transmitted. This would be done without the need for transmitters, antennas, large power supplies or memory devices to be retrieved at a later date or at a later time. In fact, the drones or other vehicles could be made significantly smaller due to the lack of need of accommodating such other more conventional components.

Although several embodiments have been described in detail for purposes of illustration, various modifications may be made without departing from the scope and spirit of the invention. Accordingly, the invention is not to be limited, except as by the appended claims.

What is claimed is:

1. A data transmission system, comprising:
a first array comprising a matrix having a plurality of quantum particles associated therewith; and
a second array disposed a distance from the first array, the second array comprising a matrix having a plurality of quantum particles associated therewith;
wherein the quantum particles of the first and second arrays are entangled so as to enable data to be transmitted therebetween.

2. The data transmission system of claim 1, wherein the matrix of the first and second arrays comprises graphene.

3. The data transmission system of claim 1, wherein the first and second arrays each include a first layer of material over a first surface of the matrix and a second layer of material over a second surface of the matrix that retains the quantum particles in association with the matrix and enable data to be applied to the quantum particles.

4. The data transmission system of claim 2, wherein at least one of the first and second layers is translucent or transparent.

5. The data transmission system of claim 2, wherein at least one of the first and second layers is comprised of a crystalline material.

6. The data transmission system of claim 2, wherein at least one of the first and second layers comprises condensed carbon.

7. The data transmission system of claim 6, wherein the condensed carbon comprises diamond.

8. The data transmission system of claim 1, wherein the graphene matrix is a single graphene layer in thickness.

9. The data transmission system of claim 2, wherein the quantum particles are disposed within the hexagonal spaces of the graphene.

10. The data transmission system of claim 1, wherein the quantum particles comprise qubits.

11. A data transmission system, comprising:
a first array comprising a graphene matrix sandwiched between first and second layers of material, at least one of the first and second layers being translucent or transparent, the graphene matrix having a plurality of quantum particles associated therewith; and
a second array disposed a distance from the first array, the second array comprising a second graphene matrix sandwiched between first and second layers of material, at least one of the first and second layers being translucent or transparent, the second graphene matrix having a plurality of quantum particles associated therewith;
wherein the quantum particles of the first and second arrays are entangled so as to enable data to be transmitted therebetween.

12. The data transmission system of claim 11, wherein at least one of the first and second layers of each of the first and second arrays comprises a crystalline material.

13. The data transmission system of claim 11, wherein at least one of the first and second layers of each of the first and second arrays comprises condensed carbon.

14. The data transmission system of claim 13, wherein the condensed carbon comprises diamond.

15. The data transmission system of claim 11, wherein the graphene matrix of each of the first and second arrays is a single graphene layer in thickness.

16. The data transmission system of claim 11, wherein the quantum particles are disposed within the hexagonal spaces of the graphene.

17. The data transmission system of claim 11, wherein the quantum particles comprise qubits.

18. A method for transmitting data, comprising the steps of:
providing a first array comprising a matrix having a plurality of quantum particles associated therewith, and a second array comprising a matrix having a plurality of quantum particles associated therewith;
entangling the quantum particles of the first and second matrices;
positioning the first and second arrays a distance from one another; and
exposing the quantum particles of the first array to data, whereby the data is transmitted to the quantum particles of the second array.

19. The method of claim 18, including the step of placing a first layer of material on a first side of the matrix and a second layer of material on a second side of the matrix of each of the first and second arrays to hold the quantum particles in association with the matrix and enable data to be applied to the quantum particles.

20. The method of claim 18, wherein at least one of the first and second layers of material are transparent or translucent.

21. The method of claim 18, wherein at least one of the first and second layers of material comprise condensed carbon.

22. The method of claim 18, wherein the quantum particles comprise qubits.
